(19) United States
(12) Patent Application Publication
(10) Pub. No.: US 2025/0224077 A1
(43) Pub. Date: Jul. 10, 2025

(54) TANK FOR STORING CRYOGENIC FLUID

(71) Applicant: L'Air Liquide, Societe Anonyme pour l'Etude et l’Exploitation des Procedes Georges Claude, Paris (FR)

(72) Inventors: Marius BOUIN, Sassenage (FR); Guillaume PETITPAS, Jouy-En-Josas (FR); Patrick BRAVAIS, Sassenage (FR); Pierrick COHARD, Sassenage (FR)

(21) Appl. No.: 19/014,157

(22) Filed: Jan. 8, 2025

(30) Foreign Application Priority Data
Jan. 8, 2024 (FR) FR 2400139

(51) Int. Cl. F17C 1/14

(52) U.S. Cl. CPC F17C 1/14; F17C 2201/0119; F17C 2201/035; F17C 2203/03; F17C 2203/0629; F17C 2203/0643; F17C 2203/0646; F17C 2221/012; F17C 2221/017; F17C 2223/0161; F17C 2227/0369

(57) ABSTRACT

The invention relates to a tank for storing cryogenic fluid, for example hydrogen or liquefied helium, having a storage shell with a cylindrical overall shape extending in a longitudinal direction that is horizontal when the tank is in the use configuration, the storage shell having, within it, a homogenization device for homogenizing the temperature of the fluid vertically in the tank, the homogenization device having at least one heat-transfer wall having a material with a coefficient of thermal conductivity of greater than 30 W·m⁻¹·K⁻¹, the transfer wall being arranged parallel to the longitudinal direction of the tank and extending vertically over 20 to 100% of the height of the storage shell and extending longitudinally over at least 50% of the length of the storage shell.

### CROSS-REFERENCE TO RELATED APPLICATIONS

This application claims the benefit of priority under 35 U.S.C. § 119 (a) and (b) to French patent application No. FR 2400139, filed Jan. 8, 2024, the entire contents of which are incorporated herein by reference.

### BACKGROUND

The invention relates to a tank for storing cryogenic fluid.

### Field of the Invention

The invention more particularly relates to a tank for storing cryogenic fluid, for example hydrogen or liquefied helium, comprising a storage shell with a cylindrical overall shape extending in a longitudinal direction that is horizontal when the tank is in the use configuration, the storage shell comprising, within it, a homogenization device for homogenizing the temperature of the fluid vertically in the tank, the homogenization device consisting of at least one heat-transfer wall consisting of a material with a coefficient of thermal conductivity of greater than 30 W·m⁻¹·K⁻¹.

### Related Art

Cryogenic tanks, in particular those containing fluids with very low specific vaporization enthalpies and significant differences in density between the liquid and vapour phases such as helium or hydrogen, tend to have significant temperature differences between their liquid and vapour phases. This results in faster pressure increases than would be observed if the two phases had similar temperatures. This phenomenon is often referred to as “stratification”.

During prolonged parking, the cryogenic tank may end up reaching its maximum pressure on account of this pressure increase. It may then be necessary to remove molecules to avoid exceeding this value. The stratification effect will amplify this drawback.

### SUMMARY OF THE INVENTION

An aim of the invention is to reduce or eliminate stratification in cryogenic tanks.

A known solution for liquid helium stores consists in providing an aluminium plate arranged in the upper part of the tank and the lower part of which is immersed in the helium liquid phase that is generally close to the lower end.

This solution partially responds to the problem and in particular it is not sufficiently satisfactory for liquefied-hydrogen tanks.

An aim of the present invention is to overcome all or some of the abovementioned drawbacks of the prior art.

To this end, the tank according to the invention, which is otherwise in accordance with the generic definition thereof given in the preamble above, is essentially characterized in that the transfer wall is arranged parallel to the longitudinal direction of the tank and extending vertically over 20 to 100% of the height of the storage shell and extending longitudinally over at least 50% of the length of the storage shell.

In addition, embodiments of the invention may have one or more of the following features:
the transfer wall extends vertically over 60 to 100%, for example 80 to 100%, and preferably 90 to 100%, of the height of the storage shell,
the transfer wall extends longitudinally over at least 80% of the length of the storage shell,
the transfer wall consists of aluminium or a stainless metal alloy,
the transfer wall has a thickness of between 1 mm and 8 mm,
the transfer wall has holes and/or corrugations and/or at least one fin extending transversely relative to the transfer wall,
the transfer wall has one or more fins extending transversely relative to the wall over a distance transverse to the transfer wall that is less than half, and preferably less than a quarter of, the diameter of the storage shell with a cylindrical overall shape,
the transfer wall is fastened to the storage shell by welding and/or screwing and/or riveting,
the tank comprises a set of circuitry and equipment in the storage shell, the transfer wall forming a support for at least some of the circuitry and/or equipment,
the tank is of the double-walled type, i.e. comprises an outer shell arranged around the storage shell with a space comprising thermal insulation.

The invention may also relate to any alternative device or method comprising any combination of the features above or below within the scope of the claims.

Further particular features and advantages will become apparent upon reading the following description, which is provided with reference to the figures, in which:

### BRIEF DESCRIPTION OF THE FIGURES

The invention will be better understood upon reading the following description, which is given solely by way of example and with reference to the appended drawings, in which:

FIG. 1 is a perspective and transparent schematic view of a tank according to one embodiment of the invention,

FIG. 2 is a cross-sectional schematic view of the tank from FIG. 1,

FIG. 3 is a schematic side view of another example of a transfer wall that may be used in a tank according to the invention,

FIG. 4 is a cross-sectional schematic view of another embodiment of the tank according to the invention.

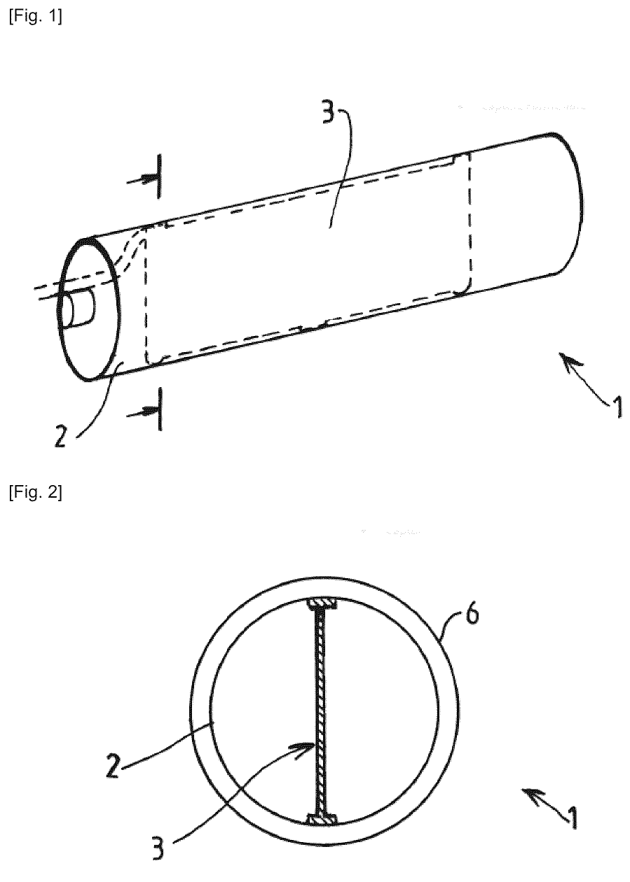

### DETAILED DESCRIPTION OF THE INVENTION

Throughout the figures, the same references relate to the same elements.

In this detailed description, the following embodiments are examples. Although the description refers to one or more embodiments, this does not mean that the features apply only to a single embodiment. Individual features of different embodiments can also be combined and/or interchanged to provide other embodiments.

The tank 1 for storing cryogenic fluid illustrated is for example intended to store hydrogen or liquefied helium. This tank 1 comprises a storage shell 2 with a cylindrical overall shape extending in a longitudinal direction that is preferably horizontal when the tank 1 is in the use configuration.

As illustrated, the storage shell 2 has a cylindrical central portion, preferably with a circular cross section and the two ends of which are closed by respective domes.

As shown schematically in FIG. 2, the tank 1 is preferably of the double-walled type, i.e. comprises an outer shell 6 arranged around the storage shell 2 with a space (for example under vacuum) comprising thermal insulation, for example multi-layer thermal insulation (MLI).

The storage shell 2 comprises, within it, a homogenization device 3 for homogenizing the temperature of the fluid vertically in the tank 1 (anti-stratification). This homogenization device comprises or consists of at least one heat-transfer wall 3 consisting of a material with a coefficient of thermal conductivity of greater than 30 W·m⁻¹·K⁻¹, said transfer wall 3 being arranged parallel to the longitudinal direction of the tank 1 and extending vertically over 20 to 100% of the height of the storage shell 2 and extending longitudinally over at least 50% of the length of the storage shell 2.

For example, the transfer wall 3 extends vertically over 60 to 100%, or 80 to 100%, and preferably 90 to 100%, of the height of the storage shell 2. Preferably, the height of the wall 3 is larger for movable tanks, which have an extended operating range (liquid level), for example between 10% and 100% of the volume. Conversely, the wall 3 may extend over a smaller height, and for example in the upper part when the tank is of the type in which the level remains essentially between 80 to 100% of the volume.

This transfer wall 3 structure occupies all or almost all of the height of the storage shell 2 and consequently limits stratification independently of the liquid level therein. This wall 3 may be a single wall.

The length of the transfer wall 3 is preferably maximized in order to promote the heat transfer between the relatively cold and hot parts.

For example, the length of the transfer wall 3 is equal or substantially equal to the length available inside the storage shell 2. In particular, the transfer wall 3 may extend beyond the central cylindrical part in order to also reach the volumes situated at the ends of the storage shell 2 at the domes.

The material of which the transfer wall 3 consists is selected so as to have high thermal conductivity at cryogenic temperatures. For example, aluminium, in particular grades 1050, 1350 or 6063.

The geometry of the transfer wall 3 may be optimized in order to increase its exchange surface area with the fluids and/or to limit the mass of the wall 3. This optimization may comprise a corrugation and/or perforations 5.

For example, the transfer wall 3 may have a corrugated shape, with corrugations that are mutually parallel in the longitudinal or vertical direction.

These particular features (or other structural modifications) make it possible to increase the exchange surface area and/or to create more turbulence in the fluid, in particular in the vertical direction.

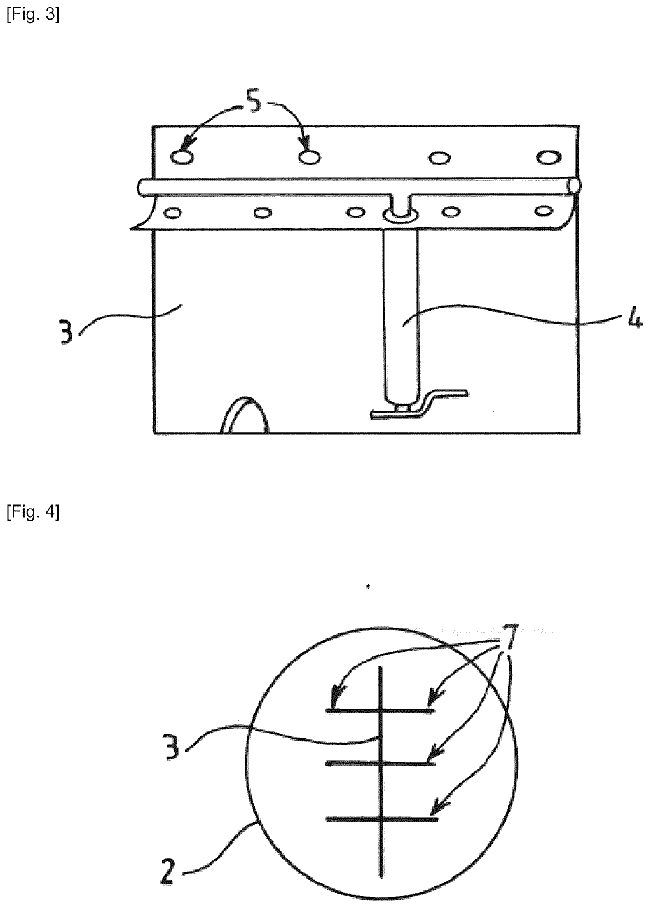

As illustrated in FIG. 3, in addition to promoting thermal transfer and therefore the uniformity of the temperature along the vertical axis and over a great length in the storage shell 2, the transfer wall 3 may form a support making it possible to install additional equipment such as instrumentation (and/or cabling), lines or mixing plates; which also facilitates the integration in the tank.

As shown schematically in FIG. 4, the transfer wall 3 may be equipped with one or more fins 7 extending transversely relative to the wall 3 over a distance transverse to the transfer wall 5 that is limited and in particular preferably less than half, or less than a quarter of, the diameter of the storage shell 2. For example, these fins 7 do not extend more than 10 cm beyond the vertical transfer wall 3. The fins 7 may be provided vertically on all or part of the transfer wall 3.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A tank for storing cryogenic fluid comprising a storage shell with a cylindrical overall shape extending in a longitudinal direction that is horizontal when the tank is in the use configuration, the storage shell comprising, within it, a homogenization device for homogenizing the temperature of the fluid vertically in the tank, the homogenization device comprising at least one heat-transfer wall comprising a material with a coefficient of thermal conductivity of greater than 30 W·m⁻¹·K⁻¹, said transfer wall being arranged parallel to the longitudinal direction of the tank and extending vertically over 20 to 100% of the height of the storage shell and extending longitudinally over at least 50% of the length of the storage shell.

2. The tank according to claim 1, wherein the transfer wall extends vertically over 60 to 100% of the height of the storage shell.

3. The tank according to claim 1, wherein the transfer wall extends longitudinally over at least 80% of the length of the storage shell).

4. The tank according to claim 1, wherein the transfer wall is comprised of aluminium or a stainless metal alloy.

5. The tank according to claim 1, wherein the transfer wall has a thickness of between 1 mm and 8 mm.

6. The tank according to claim 1, wherein the transfer wall has holes and/or corrugations and/or at least one fin extending transversely relative to the transfer wall.

7. The tank according to claim 6, wherein the transfer wall has one or more fins extending transversely relative to the wall over a distance transverse to the transfer wall that is less than half of, the diameter of the storage shell with a cylindrical overall shape.

8. The tank according to claim 1, wherein the transfer wall is fastened to the storage shell by welding and/or screwing and/or riveting.

9. The tank according to claim 1, further comprising a set of circuitry and equipment in the storage shell, the transfer wall forming a support for at least some of the circuitry and/or equipment.

10. The tank according to claim 1, comprising a double-walled configuration with a space comprising thermal insulation.
